(19) United States
(12) Patent Application Publication
(10) Pub. No.: US 2025/0272475 A1
(43) Pub. Date: Aug. 28, 2025

(54) GENERATING CONTENT UPDATE SYNOPSES USING A LARGE LANGUAGE MODEL

(71) Applicant: Dropbox, Inc., San Francisco, CA (US)

(72) Inventors: Eric Cunningham, Kirkland, WA (US); Kevin Altschuler, Cambridge, MA (US); Bradley Crossen, Texas City, TX (US); Jongmin Baek, Foster City, CA (US); Laura Mikulay, Somerville, MA (US); Michael Lyons, Brookline, MA (US); Patricia Balik, Seattle, WA (US); Sarah Andrabi, Seattle, WA (US); Theo Champlin, Hawthorne, CA (US); Tejas Patel, Bellevue, WA (US)

(21) Appl. No.: 18/652,540

(22) Filed: May 1, 2024

Related U.S. Application Data
(60) Provisional application No. 63/557,725, filed on Feb. 26, 2024.

(51) Int. Cl. G06F 40/166; G06F 40/194; G06F 40/40

(52) U.S. Cl. CPC G06F 40/166; G06F 40/194; G06F 40/40

(57) ABSTRACT

The present disclosure relates to systems, non-transitory computer-readable media, and methods for generating and providing content update synopses using a large language model. In particular, in some embodiments, the disclosed systems determine, for a collaborative workspace of a content management system, activity metadata defining user account activity across a plurality of user accounts performing actions within the collaborative workspace. Further, the disclosed systems can generate, from the activity metadata, a text representation of the user account activity indicating the actions within the collaborative workspace that occur between a first timestamp and a second timestamp. Additionally, the disclosed systems can generate a summary generation prompt from the text representation of the user account activity. Moreover, the disclosed systems can generate an activity summary for the user account activity within the collaborative workspace between the first timestamp and the second timestamp by providing the summary generation prompt to a large language model.

### CROSS-REFERENCE TO RELATED APPLICATIONS

This application claims priority to and the benefit of U.S. Provisional Patent Application No. 63/557,725, filed on Feb. 26, 2024, which is incorporated herein by reference in its entirety.

### BACKGROUND

Recent years have seen significant improvements in technology for tracking and displaying user account activity such as changes to shared digital spaces (e.g., shared drives, folders, documents, etc.). For example, existing systems can display simple notations or icons indicating individual activity events occurring within shared digital spaces, such as comments or edits made to a shared document. To illustrate, conventional systems can indicate changes made to shared digital spaces through real-time display of edits, version histories, comment logs, and activity streams.

Although conventional systems can track and display changes to shared digital spaces, such systems have a number of problems in relation to flexibility of operation and efficiency. For instance, conventional systems demonstrate operational inflexibility when displaying changes to shared digital spaces. Specifically, conventional systems are often limited to indicating specific content change events that occur within documents or shared spaces. For example, the event tracking of many existing systems is limited to identifying and displaying activity information indicating information about individual, discrete change events, such as times when change events occur and/or user accounts making the changes.

In addition to their inflexibility, some conventional systems are also inefficient. For example, existing systems often generate and provide inefficient user interfaces that display individual change events hidden inside many different layers and interfaces within shared digital spaces. Indeed, some conventional systems require navigating through a plurality of layers and interfaces distributed through a variety of organizational levels to generate and/or access content change information. For example, to display activity changes for a shared drive, many conventional systems follow a similar multi-interface paradigm of drilling down to specific content items to display individual content change events for the content items. Indeed, many existing systems require displaying a first interface showing the contents of the shared drive along with icons or other indications that changes have been made to specific content items within the shared drive. To present specific changes to a content item within a folder of the shared drive, many existing systems require navigating to a second interface depicting the contents of the folder, navigating to the content item within the folder, and then navigating to a third interface to present content changes to the specific content item. Such navigational inefficiency only increases with a larger quantity of folders and content items within the digital space.

These along with additional problems and issues exist with regard to conventional file sharing systems.

### SUMMARY

Embodiments of the present disclosure provide benefits and/or solve one or more of the foregoing or other problems in the art with systems, non-transitory computer-readable media, and methods for generating and providing content update synopses using a large language model. In particular, the disclosed systems can identify and compare user account activity of a collaborative workspace (or a content item) at different timepoints. Indeed, the disclosed systems can identify and compare states of the collaborative workspace at the different timepoints. For example, the disclosed systems can compare states of user account activity within a collaborative workspace and/or can compare states of actual digital content reflected at the different timepoints. Moreover, the disclosed systems can generate a summary of the user account activity and/or content changes of the collaborative workspace by generating and providing a summary generation prompt to a large language model. Additionally, the disclosed systems can generate a user interface for displaying, on a client device, the summaries as well as user interface elements for customizing the summaries.

Additional features and advantages of one or more embodiments of the present disclosure are outlined in the description which follows, and in part can be determined from the description, or may be learned by the practice of such example embodiments.

### BRIEF DESCRIPTION OF THE DRAWINGS

The detailed description provides one or more embodiments with additional specificity and detail through the use of the accompanying drawings, as briefly described below.

FIG. 1 illustrates a schematic diagram of an example system environment for implementing an activity difference system in accordance with one or more embodiments.

FIG. 2 illustrates an example overview of generating a user account activity summary or content change summary for a collaborative workspace in accordance with one or more embodiments.

FIG. 3 illustrates an example overview of comparing activity metadata of the collaborative workspace and generating a text representation of the comparison in accordance with one or more embodiments.

FIG. 4 illustrates an example overview of comparing content of a collaborative workspace at different timepoints and generating a text representation of the comparison in accordance with one or more embodiments.

FIG. 5 illustrates an example overview of generating an activity or content change summary utilizing a large language model in accordance with one or more embodiments.

FIGS. 6A and 6B illustrate an example summary generation interface and various operations performable from the summary generation interface in accordance with one or more embodiments.

FIGS. 7-9 illustrate example series of acts for providing synopses of user account activity changes and/or content changes using a large language model in accordance with one or more embodiments.

FIG. 10 illustrates a block diagram of an example computing device for implementing one or more embodiments of the present disclosure.

FIG. 11 illustrates an example environment for a content management system in accordance with one or more implementations.

### DETAILED DESCRIPTION

This disclosure describes one or more embodiments of an activity difference system that generates and provides synopses of user account activity changes and/or actual content changes using a large language model. In particular, the activity difference system can identify and compare user account activity and/or digital content of a collaborative workspace at different timepoints. Indeed, the activity difference system can generate a synopsis or a summary of changes to update a user account upon re-accessing a collaborative workspace after a time away and/or for changes within a custom timespan. In some cases, the activity difference system can generate text representations of user account activity changes and/or content changes to use as part of a summary generation prompt. Moreover, the activity difference system can generate a summary of the user account activity and/or the content changes to the collaborative workspace by providing the summary generation prompt to a large language model. Additionally, the activity difference system can generate a user interface for displaying, on a client device, the summary as well as user interface elements for customizing the summary.

As mentioned above, in some embodiments, the activity difference system identifies and compares user account activity of a collaborative workspace at different timepoints. For example, the activity difference system determines user account activity from server file journal (SFJ) metadata and/or other activity metadata that indicates operations instigated by various user accounts as well as timestamps for the operations. Indeed, the activity difference system can determine user account activity by extracting server metadata at different user-account-specific timepoints, such as a time of a user account accessing the collaborative workspace and a most recent previous access of the collaborative workspace by the user account. Further, the activity difference system compares the user account activity at the different timepoints to determine changes in the user account activity at the different timepoints.

In addition or alternatively to determining changes in user account activity, in some implementations, the activity difference system identifies and compares content changes to a collaborative workspace at different timepoints. For example, the activity difference system determines states of digital content of the collaborative workspace at different timepoints. To illustrate, the activity difference system determines a state of digital content at a first timestamp and a state of digital content at a second timestamp. Moreover, the activity difference system compares the digital content of the collaborative workspace at the two timepoints to determine changes in the digital content that occurred between the timepoints.

To generate a summary for user account activity and/or content changes, in one or more embodiments, the activity difference system generates a summary generation prompt for providing to a large language model. As part of generating the summary generation prompt, the activity difference system generates or extracts text representations of the changes to the user account activity and/or content changes of the collaborative workspace. For example, the activity difference system can generate a text version of server metadata defining user account activity and/or a text version (e.g., a difference file) of content deltas between states of digital content. Furthermore, the activity difference system can generate instructions for generating a summary generation prompt to combine with the text representation (of the user account activity and/or the content changes) to generate the summary generation prompt.

As noted previously, in some embodiments, the activity difference system generates a summary or synopsis of the user account activity and/or the content changes to the collaborative workspace by providing the summary generation prompt to a large language model. Further, in some implementations, the activity difference system generates a user interface for displaying the summaries, on a client device, along with user interface elements for customizing the summaries. Indeed, in these or other embodiments, the activity difference system generates summaries customized according to various parameters such as one or more user accounts, custom times, types of user account changes, etc.

As suggested above, in one or more embodiments, the activity difference system provides a variety of technical advantages relative to existing systems. For example, by generating user account activity and content change summaries for shared digital content, the activity difference system improves flexibility relative to conventional systems. Indeed, the activity difference provides the flexibility of generating a summary of content changes (and/or account activity changes) rather than simply a listing of individual, discrete change events. As part of the improved flexibility, the activity difference system provides specific interface tools for customizing summary generation, from customizing the timepoints bookending the summary generation period to selecting the types of activity and/or content changes to summarize. Indeed, as opposed to prior systems that are fixed to tracking individual events, the activity difference system provides the flexibility of customizing the parameters for summarizing and presenting content and/or activity updates.

Due at least in part to improving flexibility over prior systems, the activity difference system further improves navigational efficiency compared to prior systems. By providing a summary generation interface that consolidates features previously found across many layers (in addition to providing new features) and interfaces into a single, centralized interface, the activity difference system improves efficiency relative to conventional systems. Specifically, compared to prior systems that require excessive numbers of user interactions for navigating through many interface layers to access account activities, the activity difference system can improve navigational efficiency by providing interface tools for generating, presenting, and customizing summaries of digital content directly in the same user interface which depicts content items of a collaborative workspace. For example, together with presenting contents of a collaborative workspace, the activity difference system can provide an interface that includes elements for customizing summary generation, including parameters to target specific content items or network locations, to target specific types of user account activity and/or content changes, to target specified timepoints, and/or to target specific user accounts. Accordingly, the activity difference system not only introduces new functionality not found in prior systems, but also reduces the number of interfaces and user interactions for generating and presenting content updates as compared to prior systems. Relatedly, the activity difference system improves computational efficiency by processing few user interactions, thereby consuming fewer computer resources, such as processing power and memory, as compared to prior systems.

As illustrated by the foregoing discussion, the present disclosure utilizes a variety of terms to describe features and advantages of the activity difference system. Additional detail is now provided regarding the meaning of such terms. For example, as used herein, the term “collaborative workspace” refers to a digital, network-based (e.g., cloud-based) interactive environment for interacting with and managing content items among multiple user accounts. A collaborative workspace can have an accompanying user interface displaying graphical elements that correspond to (e.g., represent or depict) a variety of digital assets. In particular, the collaborative workspace can include selectable and editable graphical elements representing digital assets such as content items, links (e.g., to websites), digital “sticky” notes, headers (e.g., that correspond folders and/or subfolders within a file management system), etc. The collaborative workspace can further include contextual information pertaining to each graphical element presented within the collaborative workspace. For instance, the location of some graphical elements (e.g., those representing folders or content items) in relation to each other within the collaborative workspace can translate to corresponding locations within the file management system.

As mentioned above, the activity difference system can generate an activity summary and/or a content change summary for a content item. As used herein, the term “digital content item” (or simply “content item”) refers to a digital object or a digital file that includes information interpretable by a computing device (e.g., a client device) to present information to a user. A digital content item can include a file or a folder such as a digital text file, a digital image file, a digital audio file, a webpage, a website, a digital video file, a web file, a link, a digital document file, or some other type of file or digital object. A digital content item can have a particular file type or file format, which may differ for different types of digital content items (e.g., digital documents, digital images, digital videos, or digital audio files). In some cases, a digital content item can refer to a remotely stored (e.g., cloud-based) item or a link (e.g., a link or reference to a cloud-based item or a web-based content item) and/or a content clip that indicates (or links/references) a discrete selection or segmented sub-portion of content from a webpage or some other content item or source. A content item can also include application-specific content that is siloed to a particular computer application but is not necessarily accessible via a file system or via a network connection. A digital content item can be editable or otherwise modifiable and can also be sharable from one user account (or client device) to another. In some cases, a digital content item is modifiable by multiple user accounts (or client devices) simultaneously and/or at different times.

As noted above, the activity difference system can generate an activity comparison by generating an activity comparison file. As used herein, the term “activity comparison file” refers to a digital file that defines or encodes changes or differences between two versions of digital data (e.g., two versions of a content item). For example, the activity comparison file can include changes or differences such as additions, deletions, or modifications to different versions of digital data.

As mentioned previously, the activity difference system can generate a summary generation prompt to provide to a large language model. As used herein, the term “summary generation prompt” refers to an instructional request or input given to a large language model for generating a summary of user account activity and/or content changes. In particular, a summary generation prompt can include summary generation instructions for eliciting a response that provides a summary or synopsis. Moreover, a summary generation prompt can also include digital content such as a file with text or one or more content items that requires summarization. For example, a summary generation prompt includes the digital content with the summary generation instructions for generating a summary or synopsis of the digital content.

As noted previously, the activity difference system can utilize a difference function to generate a content difference file. As used herein, the term “content difference file” (or simply “difference file”) refers to a file that defines or encodes differences between digital content. In particular, a content difference file represents differences between digital files (or sets of digital files). For example, the difference file can be a non-textual representation of the differences between files such as a file showing changes between an image, a video, etc. In another example, a content difference file can be a textual representation describing or otherwise textually reflecting the differences between digital files showing additions, deletions, or modifications between the digital files (e.g., an original file and an updated file). Relatedly, the term “difference function,” as used herein, refers to a computer program, command, or process that compares two files. For example, the difference function can compare non-textual digital files such as images or videos to identify differences. In another example, the difference file can compare text based digital files line by line to output the differences between them in a text format (e.g., to a text representation file or a difference file).

As previously mentioned, the activity difference system can generate an activity summary and/or a content change summary for a collaborative workspace. As used herein, the term “activity summary” refers to a summary or synopsis of activity changes between digital content. Specifically, an activity summary includes a description of user account activity between original and modified digital content (e.g., a collaborative workspace or a content item). For example, an activity summary includes a synopsis of user account activity between digital content between two timepoints. Relatedly, the term “content change summary,” as used herein, refers to a summary or synopsis of actual changes to digital content. Specifically, a content change summary includes a description of content changes between original and modified digital content (e.g., a collaborative workspace or a content item). For example, a content change summary includes a synopsis of content changes to digital content occurring between two timepoints. In some examples, a content change summary can be, or include, digital content itself, such as a content item or portions of a content item (e.g., a video clip or an image).

As previously noted, the activity difference system generates an activity and/or a content change summary using a large language model. As used herein, the term “large language model” refers to a machine learning model trained to perform computer tasks to generate or identify content items in response to trigger events (e.g., user interactions, such as text queries and button selections). In particular, a large language model can be a neural network with many parameters trained on large quantities of data (e.g., unlabeled text) using a particular learning technique (e.g., self-supervised learning). For example, a large language model can include parameters trained to generate or identify content items based on various contextual data, including graph information from a knowledge graph and/or historical user account behavior.

Relatedly, the term “neural network” refers to a machine learning model that can be trained and/or tuned based on inputs to determine classifications, scores, or approximate unknown functions. For example, a neural network includes a model of interconnected artificial neurons (e.g., organized in layers) that communicate and learn to approximate complex functions and generate outputs (e.g., content change summaries or user account activity summaries) based on a plurality of inputs provided to the neural network. In some cases, a neural network refers to an algorithm (or set of algorithms) that implements deep learning techniques to model high-level abstractions in data. A neural network can include various layers such as an input layer, one or more hidden layers, and an output layer that each perform tasks for processing data. For example, a neural network can include a deep neural network, a convolutional neural network, a recurrent neural network (e.g., an LSTM), a graph neural network, or a generative adversarial neural network. Upon training, such a neural network may become a large language model.

As mentioned above, the activity difference system can generate a text description using a content conversion model. As used herein, the term “content conversion model” refers to a model (e.g., a machine learning model) or a collection of models for converting digital content from one format, type, or code structure to another. For example, the content conversion model can convert one type of content item to another type of content item. To illustrate further, the content conversion model can convert an activity comparison file to a text file or file containing text descriptions. Similarly, the content conversion model can convert a content item such as a video or a photograph to a text file or a file containing text descriptions of the video or photograph content. The content conversion model can include instructions for utilizing various application programming interfaces (APIs) to convert content items from one type to another, such as APIs to access a model for extracting data, APIs to access transcription models, etc.

As noted above, the activity difference system can generate a text representation from an activity comparison or a content comparison. As used herein, the term “text representation” refers to a representation of digital content in text form. In particular, a text representation can include the text of an activity comparison file, a content item or a text description of one or more content item(s) or portions thereof. To illustrate, a text representation can include, but is not limited to, the text of digital content (e.g., a content item) such as the text of an electronic document, a text description of non-text portions of an electronic document, a text description of a digital image, a digital video, or other content as described above. For example, a text representation can include a string of characters that describe, define, or represent a content item.

As mentioned previously, the activity difference system extracts activity metadata from a collaborative workspace. As used herein, the term “activity metadata,” refers to server metadata such as file system metadata encompassing various types of information associated with files and directories within the file system. Specifically, activity metadata can include attributes such as file name, size, type, creation date, modification date, access permissions, user-account-specific access timepoints, directory structure, file ownership, and file system-specific details. For example, activity metadata can include SFJ such as data on changes made to files and directories on a server, timestamps, user actions, and access control settings.

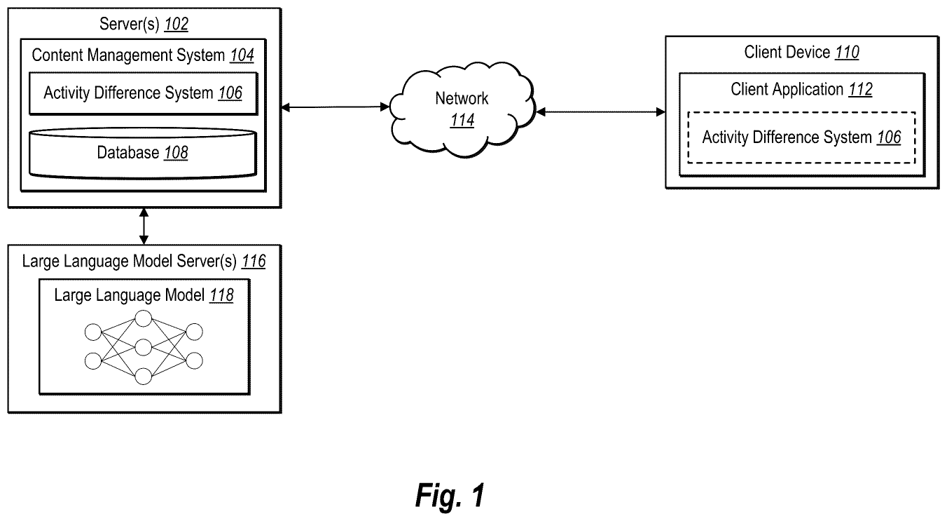

Additional detail regarding the activity difference system will now be provided with reference to the figures. For example, FIG. 1 illustrates a schematic diagram of an example system environment for implementing an activity difference system 106 in accordance with one or more embodiments. An overview of the activity difference system 106 is described in relation to FIG. 1. Thereafter, a more detailed description of the components and processes of the activity difference system 106 is provided in relation to the subsequent figures.

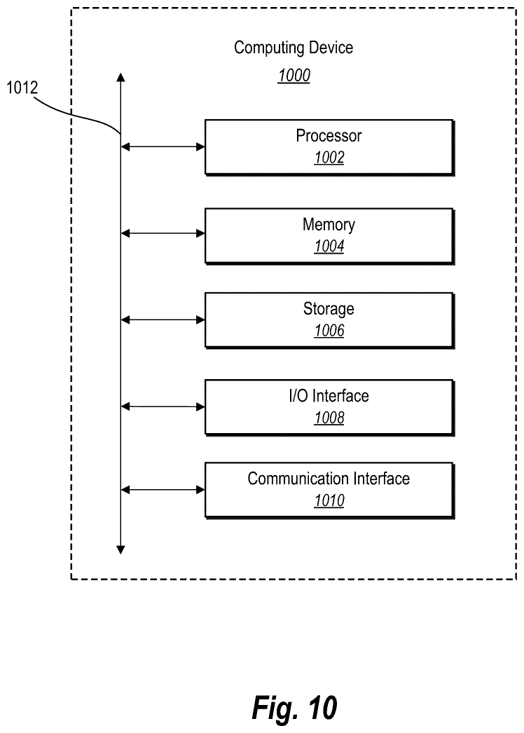

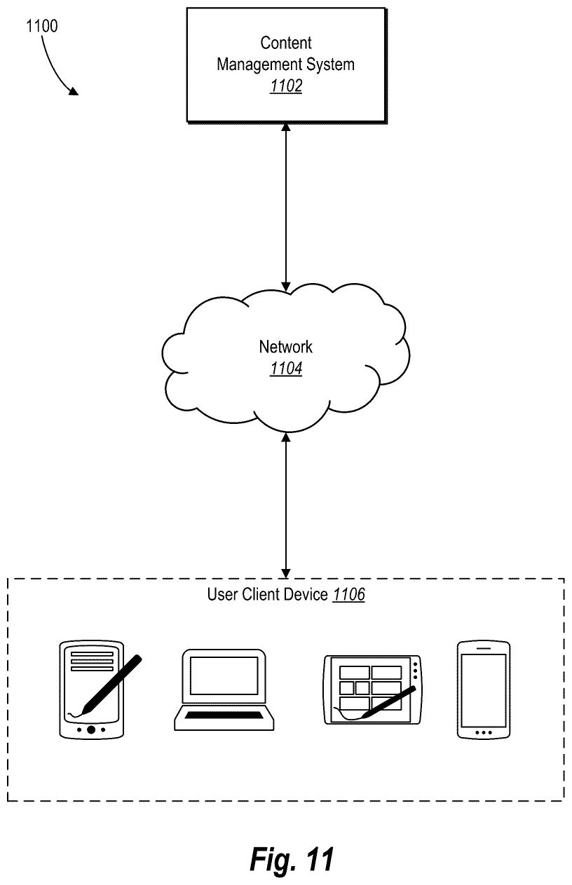

As shown, the environment includes server(s) 102, a client device 110, a network 114, and large language model server(s) 116. Each of the components of the environment can communicate via the network 114. In some instances, the server(s) 102 communicate directly with the large language model server(s) 116 directly as shown in FIG. 1. The network 114 may be any suitable network over which computing devices can communicate. Example networks are discussed in more detail below in relation to FIGS. 10-11.

As mentioned above, the example environment includes client device 110. The client device 110 can be one of a variety of computing devices, including a smartphone, a tablet, a smart television, a desktop computer, a laptop computer, a virtual reality device, an augmented reality device, or another computing device as described in relation to FIGS. 10-11. The client device 110 can communicate with the server(s) 102 and/or the database 108 via the network 114. For example, the client device 110 can receive user input from a user interacting with the client device 110 (e.g., via the client application 112) to, for instance, access, generate, modify, or share a content item, to collaborate with a co-user of a different client device, or to select a user interface element (e.g., for generating a summary of user account activity and/or content changes). In addition, the activity difference system 106 on the server(s) 102 can receive information relating to various interactions with content items and/or user interface elements based on the input received by the client device 110 (e.g., to access content items, generate summaries, customize summary generation parameters, or perform some other action).

As shown, the client device 110 can include a client application 112. In particular, the client application 112 may be a web application, a native application installed on the client device 110 (e.g., a mobile application, a desktop application, etc.), or a cloud-based application where all or part of the functionality is performed by the server(s) 102. Based on instructions from the client application 112, the client device 110 can present or display information, including a user interface for presenting content items or update summaries from the content management system 104 or from other network locations.

As illustrated in FIG. 1, the example environment also includes the server(s) 102. The server(s) 102 may generate, track, store, process, receive, and transmit electronic data, such as digital content items, summaries, server metadata indicating user account activity and/or content changes, interface elements, interactions with digital content items, interactions with interface elements, and/or interactions between user accounts or client devices. For example, the server(s) 102 may receive data from the client device 110 in the form of an indication of a user account accessing a content item or a collaborative workspace. In addition, the server(s) 102 can transmit data to the client device 110 in the form of summary generation interface that includes an automatically (e.g., without user interaction for prompting) generated summary of user account activity and/or content changes that occurred since the user account last accessed the content item or the collaborative workspace. Indeed, the server(s) 102 can communicate with the client device 110 to send and/or receive data via the network 114. In some implementations, the server(s) 102 comprise(s) a distributed server where the server(s) 102 include(s) a number of server devices distributed across the network 114 and located in different physical locations. The server(s) 102 can comprise one or more content servers, application servers, communication servers, web-hosting servers, machine learning server, and other types of servers.

As shown in FIG. 1, the server(s) 102 can also include the activity difference system 106 and the database 108 as part of a content management system 104. The content management system 104 can communicate with the client device 110 to perform various functions associated with the client application 112 such as managing user accounts, managing content collections, managing collaborative workspaces, managing content items, and facilitating user interaction with the collaborative workspaces, the content collections, and/or content items. Indeed, the content management system 104 can include a network-based smart cloud storage system to manage, store, and maintain content items and related data across numerous user accounts, including user accounts in collaboration with one another. In some embodiments, the activity difference system 106 and/or the content management system 104 utilize the database 108 to store and access information such as digital content items.

FIG. 1 further illustrates large language model server(s) 116. In particular, the large language model server(s) 116 can host or house a large language model 118 for access by the activity difference system 106. Indeed, the activity difference system 106 can access the large language model 118. For example, the large language model server(s) 116 can include a server location hosting the large language model 118 that is external to the activity difference system 106. In some cases, the large language model server(s) 116 are external to the activity difference system 106, but the activity difference system 106 can nevertheless access and utilize the large language model 118 via one or more plugins, APIs, or other network-based access protocols.

Although FIG. 1 depicts the activity difference system 106 located on the server(s) 102, in some implementations, the activity difference system 106 may be implemented by (e.g., located entirely or in part on) one or more other components of the environment. For example, the activity difference system 106 may be implemented by the client device 110. For example, the client device 110 can download all or part of the activity difference system 106 for implementation independent of, or together with, the server(s) 102.

In some implementations, though not illustrated in FIG. 1, the environment may have a different arrangement of components and/or may have a different number or set of components altogether. For example, the client device 110 may communicate directly with the activity difference system 106, bypassing the network 114. As another example, the environment can include the database 108 located external to the server(s) 102 (e.g., in communication via the network 114), located on the server(s) 102 as illustrated in FIG. 1, and/or on the client device 110.

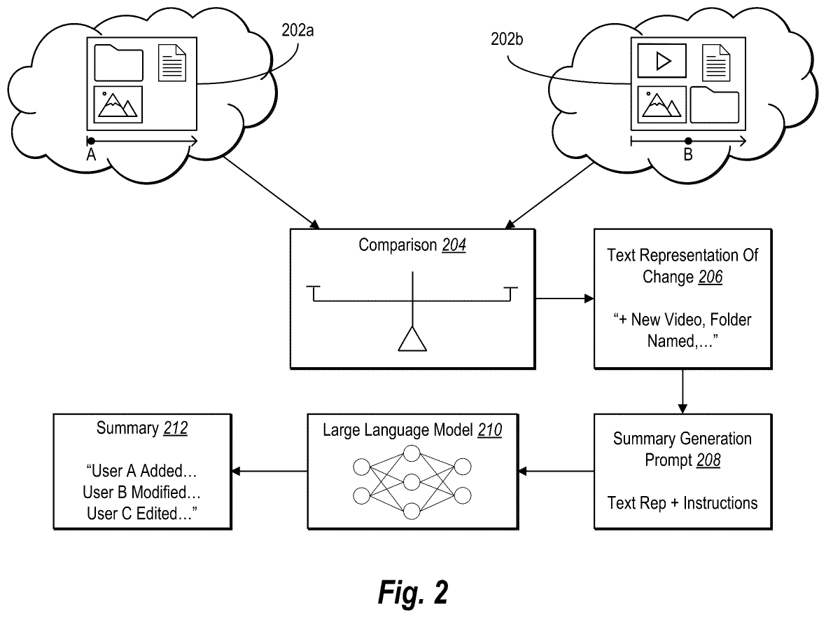

As previously mentioned, the activity difference system 106 can generate a user account activity summary and/or a content change summary for a collaborative workspace (and/or a content item) using a large language model. FIG. 2 illustrates an example overview of generating a user account activity summary or content change summary for a collaborative workspace in accordance with one or more embodiments.

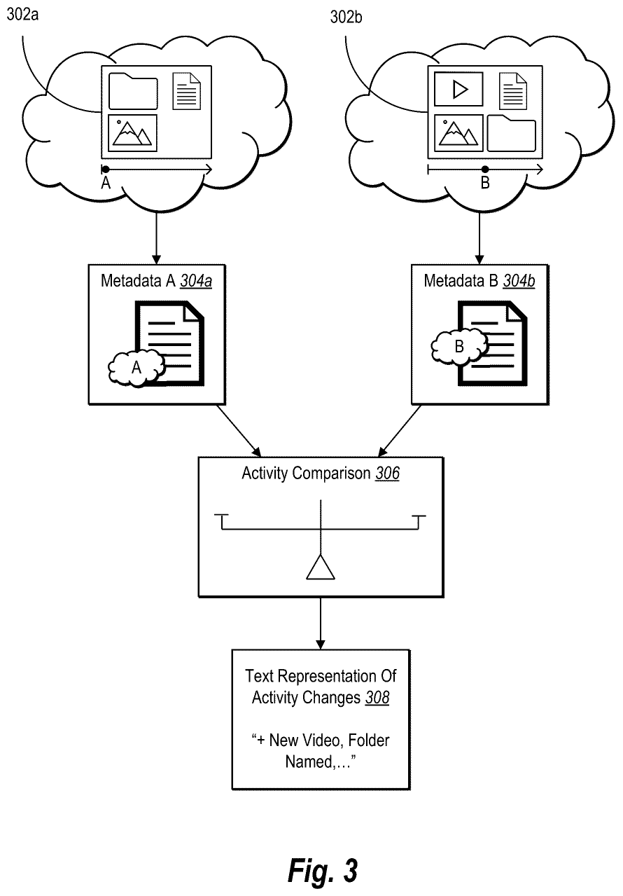

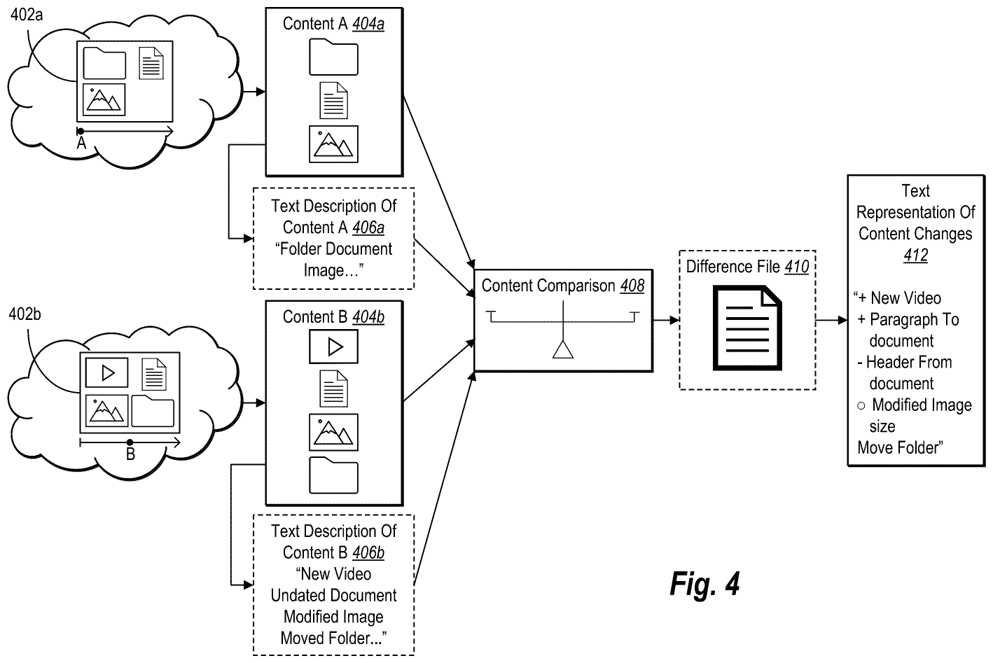

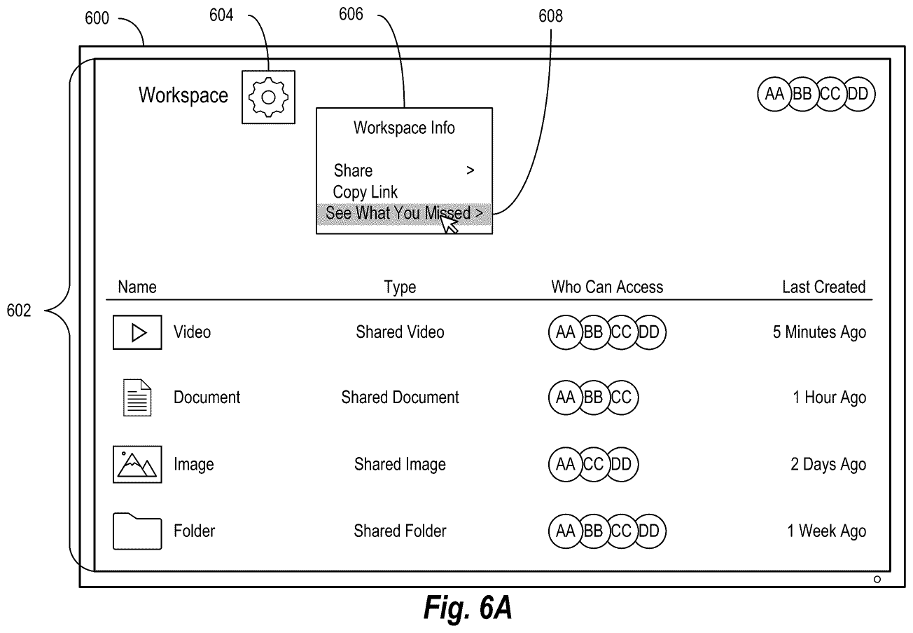

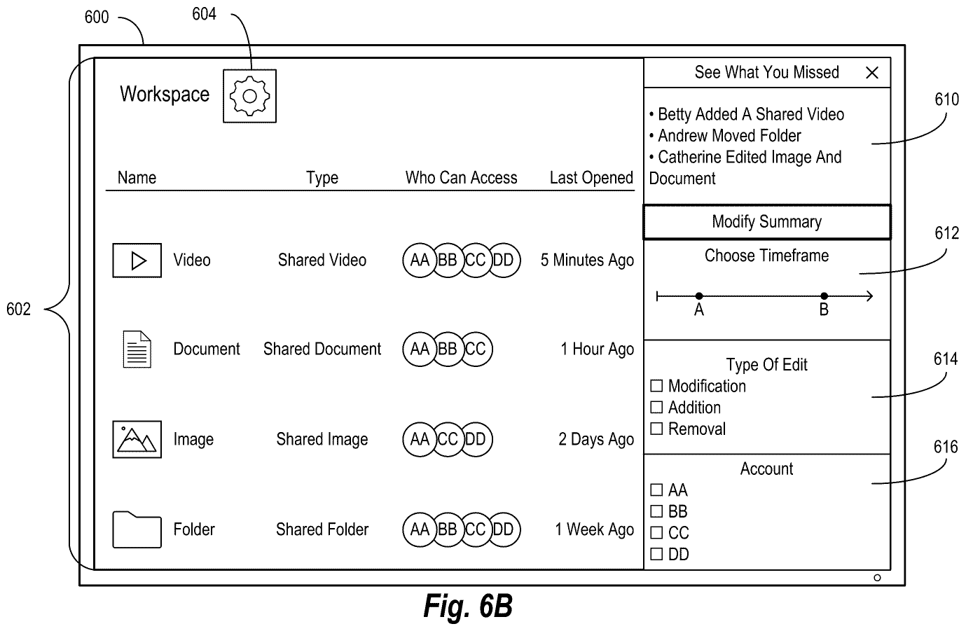

As shown in FIG. 2, the activity difference system 106 can determine states of a collaborative space at different timestamps. For example, the activity difference system 106 can determine or extract metadata (e.g., a server log) indicating user account activity at different timepoints. In some cases, the activity difference system 106 can also or alternatively determine or extract actual digital content of the collaborative space at different timepoints. As shown, the activity difference system 106 determines a first state of a collaborative workspace 202a based on user account activity and/or digital content within the collaborative workspace 202a at timestamp A. Additionally, the activity difference system 106 determines a second state of the collaborative workspace 202b (the same collaborative workspace) based on user account activity and/or digital content within the collaborative workspace 202b at timestamp B. In one or more embodiments, the activity difference system 106 defines or determines timestamps A and B utilizing custom input times (e.g., as discussed below with respect to FIGS. 6A and 6B). Alternatively, the activity difference system 106 can define timestamps A and B automatically by determining times of a previous and current session with the collaborative workspace 202 in response to detecting access of a user account to the collaborative workspace 202 (as discussed in further detail with respect to FIGS. 3 and 4).

As also shown in FIG. 2, the activity difference system 106 can perform a comparison 204. To elaborate, the activity difference system 106 can compare user account activity performed within, and/or content changes to, a collaborative workspace 202. In some cases, the activity difference system 106 performs the comparison 204 by comparing server logs from timestamps A and B and/or by comparing contents of the collaborative workspace 202a and the collaborative workspace 202b (at timestamps A and B). Indeed, the activity difference system 106 can compare server logs to determine a difference or a delta between the logged user account activity having taken place up to timestamp A and the logged user account activity having taken place up to timestamp B. Additionally or alternatively, the activity difference system 106 can compare digital contents to determine a difference or a delta between actual content reflected or stored at timestamp A versus that at timestamp B.

As also shown, the activity difference system 106 can generate a text representation 206 of the comparison 204. Specifically, the activity difference system 106 can generate the text representation 206 by generating a text description of the comparison 204. For example, the activity difference system 106 generates the text representation 206 as a text-based description of actions within the collaborative workspace occurring between timestamps A and B. Additionally or alternatively, the activity difference system 106 generates the text representation 206 as a text-based description of actual content changes of the collaborative workspace made between timestamps A and B.

Furthermore, the activity difference system 106 can generate a summary generation prompt 208. For example, the activity difference system 106 generates the summary generation prompt 208 using the text representation 206. As part of the summary generation prompt 208, the activity difference system 106 also generates summary generation instructions. Indeed, the activity difference system 106 combines text-based instructions (and other contextual information) with the text representation 206 to generate the summary generation prompt for providing to the large language model 210.

As further illustrated in FIG. 2, the activity difference system 106 can provide the summary generation prompt 208 to a large language model 210 for generating a summary 212. Indeed, the activity difference system 106 can generate a summary 212 such as an activity summary for the determined user account activity occurring between the timestamps A and B. Additionally or alternatively, the activity difference system 106 generates a content change summary for the determined content changes, between the collaborative workspaces 202a and 202b. Moreover, the activity difference system 106 can generate a user interface for display of the collaborative workspace and the summary 212 as well as various user interface elements for customization of the summary 212 as discussed in more detail with respect to FIGS. 6A and 6B.

As noted previously, the activity difference system 106 can compare user account activity within a collaborative workspace at different user-account-specific timepoints and generate a text representation of the comparison. Indeed, in some embodiments, the activity difference system 106 can extract server metadata from a collaborative workspace for comparison and generate the text representation from the comparison. FIG. 3 illustrates an example overview of comparing activity metadata of the collaborative workspace and generating a text representation of the comparison in accordance with one or more embodiments.

As shown in FIG. 3, the activity difference system 106 determines user account activity of the collaborative workspace 302 at different timepoints (e.g., timepoint A and timepoint B). For example, the activity difference system 106 determines metadata indicating various user account actions, such as accesses, exits, reads, shares, modifications, comments, receipts, scrolls, and clicks within collaborative workspace 302a at timepoint A and collaborative workspace 302b at timepoint B. In some cases, the metadata indicates user account activity for the collaborative workspace 302 as a whole and/or for individual folders, collections, or content items within the collaborative workspace 302. For instance, the activity difference system 106 can maintain a global metadata log for the collaborative workspace 302, where each logged action includes a label for the action type, a timestamp, the user account performing the action, and/or the content item where the action takes place. Indeed, while FIGS. 3-4 illustrate the activity difference system 106 identifying changes (e.g., user account activity and/or content changes) of a collaborative workspace, in some implementations, the activity difference system 106 can also determine and summarize changes for specific content items, collections, folders, user accounts, teams, and/or filetypes.

In some embodiments, the activity difference system 106 determines the user account activity and/or the timepoints A and B automatically in response to an access request (or in response to detecting access to the collaborative workspace). For example, in response to receiving an access request to access the collaborative workspace 302 from a user account with access to the collaborative workspace, the activity difference system 106 determines the timepoints A and B. Indeed, the activity difference system 106 can define a timestamp for timepoint A and a timestamp for timepoint B.

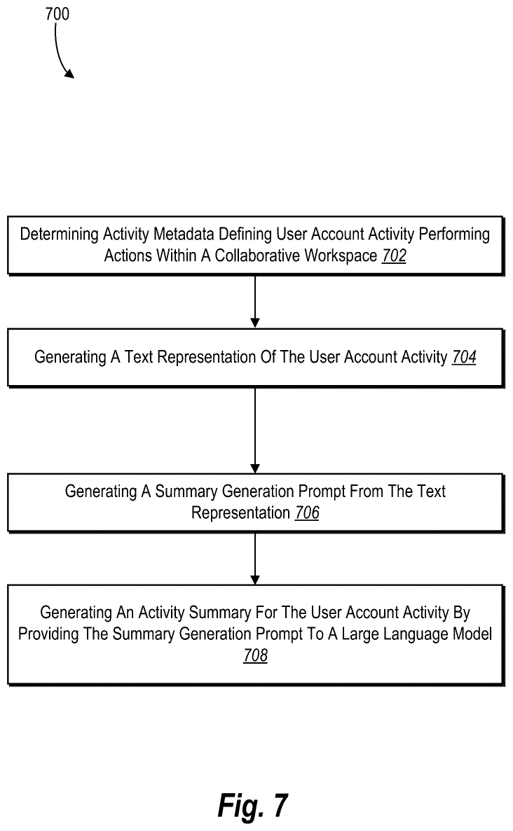

To illustrate, in these or other embodiments, the activity difference system 106 defines the timestamp for timepoint A as a time of a most recent previous access of the collaborative workspace, such as a moment of termination of a previous session of the user account with the collaborative workspace 302 (e.g., the time of most recently leaving the collaborative workspace 302a). Moreover, the activity difference system 106 determines the second timestamp at the next successive time the user account accesses the collaborative workspace. For instance, the activity difference system 106 determines timepoint B as a time of the access request by the same user account, such as a current session (e.g., accessing the collaborative workspace 302b). In one or more embodiments, the activity difference system 106 defines one or both timestamps by utilizing user input (e.g., via a user interface element) to determine the time (i.e., the timepoint) of the timestamps as discussed in more detail with respect to FIG. 7. Furthermore, in one or more implementations, the activity difference system 106 can define and/or determine the timestamps at specific intervals, such as at the beginning and ending of a work shift, a day, a week, etc.

As further shown in FIG. 3, the activity difference system 106 extracts the activity metadata 304 from the collaborative workspaces 302a and 302b. Specifically, the activity difference system 106 determines the user account activity by determining and extracting activity metadata 304 defining user account activity across a plurality of user accounts performing actions within the collaborative workspace 302. To illustrate, the activity difference system 106 determines and extracts activity metadata 304a from collaborative workspace 302a at the first timestamp and activity metadata 304b from the collaborative workspace 302a at the second timestamp as shown in FIG. 3. Indeed, as previously mentioned, the activity difference system 106 can compare server logs to determine a difference or a delta between the logged user account activity having taken place up to timestamp A and the logged user account activity having taken place up to timestamp B. Additionally or alternatively, the activity difference system 106 can compare digital contents to determine a difference or a delta between actual content reflected or stored at timestamp A versus that at timestamp B.

In some embodiments, the activity difference system 106 performs an activity comparison 306 of the activity metadata 304a and 304b. Specifically, the activity difference system 106 can utilize a difference function to process the activity metadata 304a and 304b, where the difference function produces or outputs a file or code that defines or represents differences between the compared metadata. Indeed, in some implementations, the activity difference system 106 can generate an activity comparison file that defines the differences in the user account activity of the collaborative workspace 302 between timestamp A and timestamp B (i.e., between collaborative workspace 302a and collaborative workspace 302b).

As also illustrated, the activity difference system 106 generates the text representation 308 of the activity comparison 306. Specifically, the activity difference system 106 generates, from the activity metadata 304a and 304b, a text representation 308 of the user account activity. For example, the activity difference system 106 can generate the text representation 308 to indicate the actions within the collaborative workspace 302 that occur between collaborative workspace 302a and collaborative workspace 302b. To illustrate, the activity difference system generates the text representation to include text descriptions such as “+new video, folder moved, image edited, document edited, +image copy, −image copy,” for the addition of a new video, the moving of a folder, the editing of an image, the editing of a document, the copying of the image, and the deletion of the copied image respectively.

In one or more embodiments, the activity difference system 106 generates the text representation 308 utilizing a content conversion model. For example, the activity difference system can utilize the content conversion model to generate the text representation 308 as described in U.S. application Ser. No. 18/469,357, filed Sep. 18, 2023, entitled GENERATING LARGE LANGUAGE MODEL OUTPUTS FROM STORED CONTENT ITEMS, the contents of which are herein incorporated by reference in their entirety. Accordingly, in these or other embodiments, the activity difference system 106 generates the text representation 308 to include a text description of the activity changes indicated in the comparison file (i.e., the activity comparison file) of the activity comparison 306.

Moreover, in one or more implementations, the activity difference system 106 processes a content item (e.g., within the collaborative workspace 302) similar to the processing of the collaborative workspace 302 as described above. For example, the activity difference system 106 determines states of the content item at different timestamps A and B, extracts the activity metadata of the content item at the different timestamps, generates the activity comparison 306, and generates the text representation 308. Indeed, the activity difference system 106 can perform each of these actions similarly for the content item as for the collaborative workspace 302.

As previously noted, the activity difference system 106 can compare content changes to a collaborative workspace (or content items within the collaborative workspace) between different timepoints and can generate a text representation of the comparison. FIG. 4 illustrates an example overview of comparing content of a collaborative workspace at different timepoints and generating a text representation of the comparison in accordance with one or more embodiments.

As shown in FIG. 4, the activity difference system 106 can determine states of content within a collaborative workspace 402 at different timestamps (e.g., timestamp A and timestamp B). Specifically, the activity difference system 106 determines state of the collaborative workspace 402a at timestamp A and the state of the collaborative workspace 402b (the same collaborative workspace) at timestamp B. Moreover, the activity difference system 106 defines or determines timestamps A and B utilizing custom input times (e.g., as described below with respect to FIGS. 6A and 6B). Additionally or alternatively, the activity difference system 106 defines or determines timestamps A and B automatically as described above with respect to FIG. 3 (e.g., in response to an access request or to detecting access).

As further illustrated in FIG. 4, the activity difference system 106 determines and extracts the digital content 404 of the collaborative workspace 402 at the different timepoints. Indeed, the activity difference system 106 determines and extracts the digital content 404a of the collaborative workspace 402a and the digital content 404b of the collaborative workspace 402b (the same collaborative workspace). To illustrate, the activity difference system 106 determines and extracts digital content such as a digital folder, a digital document, and a digital image as shown in FIG. 4. Furthermore, the activity difference system 106 determines and extracts digital content 404b such as an added digital video, a modified digital document, a modified digital image, and the moved digital folder as also shown in FIG. 4.

As illustrated in FIG. 4, in some embodiments, the activity difference system 106 can generate a text description 406 of the digital content 404a and 404b. For example, the activity difference system 106 can generate a text description of the content items within the collaborative workspace. To illustrate, the activity difference system 106 extracts text from content items containing text such as electronic documents, electronic communications, etc. Further, in some cases, the activity difference system 106 utilizes a content conversion model to generate a text description of content items that lack text such as a digital video or digital image. Moreover, the activity difference system 106 generates the text descriptions 406a and 406b by combining text descriptions of the plurality of content items within the collaborative workspace at the two timepoints. To illustrate, the activity difference system can generate a text description by generating or extracting a transcript of a video, by generating a text description of an image, by generating and combing text of an image within a document with text of the document, etc.

In some embodiments, as shown in FIG. 4, the activity difference system 106 generates the content comparison 408 from the text descriptions 406a and 406b. Specifically, the activity difference system 106 generates the content comparison 408 by comparing the text descriptions 406a and 406b. Accordingly, the activity difference system 106 generates the content comparison 408 to indicate the changes in the digital content as reflected by the respective text descriptions of that content.

Additionally or alternatively, the activity difference system 106 can generate the content comparison 408 directly from the digital content 404a and 404b. In these or other embodiments, the activity difference system 106 generates the content comparison 408 by utilizing a difference function to determine the differences between different versions (e.g., from timestamp A and timestamp B) of the digital content 404a and 404b or of specific content items thereof. To illustrate, the activity difference system 106 compares the different versions of the digital content 404a and the 404b to determine changes such as the addition of an item (e.g., the addition of a digital video to the collaborative workspace 402b). To further illustrate, the activity difference system 106 compares the different versions of the digital folder (including the folder metadata) to determine that the folder has been moved, renamed, has had items added or removed, etc. To further illustrate, the activity difference system 106 compares different versions of the digital image to determine that various changes have been made to the digital image.

As further illustrated in FIG. 4, in some implementations, the activity difference system 106 generates a content difference file (i.e., difference file 410). For example, the activity difference system 106 generates the difference file 410 utilizing a difference function. In these or other embodiments, the activity difference system 106 generates the difference file 410 to define the differences between the digital content 404a and the digital content 404b. Specifically, in one or more embodiments, the activity difference system 106 generates the difference file 410 when comparing the content of the digital content 404a and 404b directly. Additionally, in one or more implementations, the activity difference system 106 can utilize the difference file 410 as the text representation 412 for generating the summary generation prompt. Additionally or alternatively, the activity difference system 106 utilizes a content comparison model to convert the difference file 410 to a text representation 412 for generating the summary generation prompt.

Further, as shown in FIG. 4, the activity difference system 106 can generate a text representation 412 of the content changes identified in the content comparison 408. Specifically, the activity difference system 106 generates the text representation 412 to identify the changes within the collaborative workspace 402 between the timestamps A and B. To illustrate, the activity difference system 106 can generate the text representation 412 to include textual descriptions of changes such as additions, deletions, or modifications to the collaborative workspace and/or specific content items therein. Additionally or alternatively, the activity difference system 106 can generate the text representation 412 (or the difference file 410) to include the actual changes and locations of the changes. For example, the text representation 412 or the difference file 410 can include an added paragraph or a removed header (i.e., the actual paragraph or header) along with the location of such items and the indication of the type of change (e.g., “+” for an addition, “−” for removal, etc.).

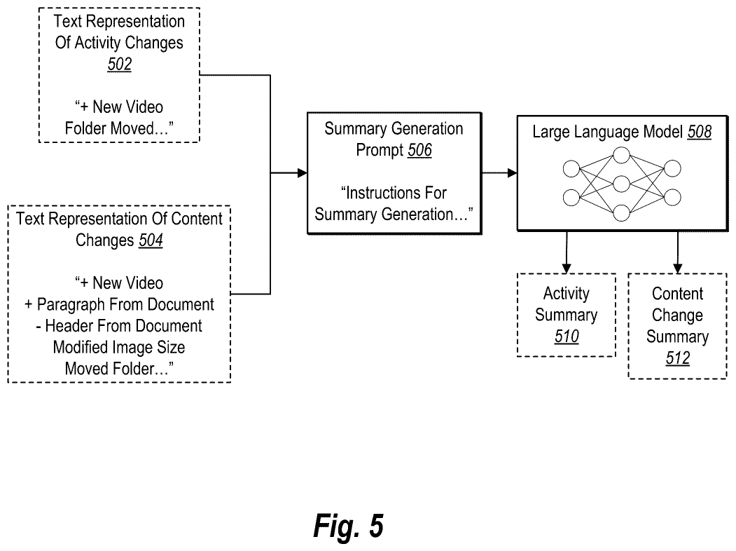

As mentioned above, the activity difference system 106 can generate and provide a summary generation prompt to a large language model for generating a summary. FIG. 5 illustrates an example overview of generating an activity or content change summary utilizing a large language model in accordance with one or more embodiments.

As shown in FIG. 5, the activity difference system 106 generates a summary generation prompt 506 from a text representation 502. Specifically, the activity difference system 106 can utilize a text representation 502 of the activity changes to the collaborative workspace (or a content item) occurring between different timestamps to generate the summary generation prompt 506. Additionally or alternatively, the activity difference system 106 generates the summary generation prompt 506 utilizing a text representation 504 of the content changes to the collaborative workspace (or a content item). In some embodiments, the activity difference system 106 utilizes a difference file to generate the summary generation prompt 506.

As further illustrated in FIG. 5, the activity difference system 106 generates summary generation instructions to generate the summary generation prompt 506. For instance, the activity difference system 106 generates the summary generation prompt 506 by combining the summary generation instructions with the text representation and/or the difference file. Moreover, the activity difference system 106 generates the summary generation instructions for directing a large language model to provide an activity summary and/or a content change summary. Furthermore, in some implementations, the activity difference system 106 generates the summary generation instructions to include specific direction regarding the formatting of the difference file.

Additionally, in one or more embodiments, the activity difference system 106 can generate custom summary generation instructions. For example, the activity difference system 106 can generate the summary generation instructions to be specific to a type of activity and/or content change or to a user account as further discussed with respect to FIGS. 6A and 6B. Further, in one or more implementations, the activity difference system 106 can customize the summary generation instructions to the user account. For instance, the activity difference system 106 can generate the instructions to focus the large language model 508 to projects frequently associated with the user account, a role assigned to the user account, etc. Indeed, the activity difference system 106 can customize the summary generation instructions to the user account by utilizing connectors or a knowledge graph (e.g., to emphasize summarizing some changes over others, based on relationships between content items and user accounts affecting the changes). Moreover, in some embodiments, the activity difference system 106 can generate the summary generation instructions to instruct the large language model 508 to provide prioritization of user-account-associated-tasks. For example, utilizing these summary generation instructions, the activity difference system 106 generates an indication of projects for prioritization specific to the user account with the activity summary 510 and/or the content change summary 512.

As also shown in FIG. 5, the activity difference system 106 generates a summary by providing the summary generation prompt 506 to the large language model 508 (housed by the content management system 104 or at a third-party server). Specifically, the activity difference system 106 can generate an activity summary 510 by providing a summary generation prompt 506 including a text representation 502 of activity changes. Furthermore, in some implementations, the activity difference system 106 generates a content change summary 512 by providing a summary generation prompt 506 including a text representation 504 of content changes. Additionally or alternatively, the activity difference system 106 can generate the content change summary 512 by providing a summary generation prompt 506 including a difference file.

Additionally, in one or more embodiments, the activity difference system 106 generates the content change summary 512 by providing versions of one or more content items (e.g., within a collaborative workspace) from different timestamps to the large language model 508 with the summary generation prompt 506. For example, the activity difference system 106 generates content change summary 512 the summary by providing a digital image from the first timestamp and the modified digital image from the second timestamp to the large language model 508 with the summary generation prompt 506. Alternatively, the activity difference system 106 can generate the summary generation prompt 506 combining the two versions of the content item/s with the summary generation instructions. In these or other embodiments, the activity difference system 106 proceeds to generate the content change summary 512 by providing the summary generation prompt 506 to the large language model 508.

Further, in one or more implementations, the activity difference system 106 can generate the content change summary 512 to include portions of the digital content. For example, the activity difference system 106 can generate the content change summary 512 to include a section of a modified digital video, a modified digital image, or other content item associated with the summary. To illustrate, the activity difference system 106 can identify video timestamps within a digital video, determine the portions of the video that have changes in the content comparison, extract the changed video clip between the video timestamps, and provide the video clip with the content change summary 512.

As noted above, the activity difference system 106 can generate a user interface for displaying the summaries on a client device. as well as user interface elements for customizing the summaries on a client device. Specifically, the activity difference system 106 can generate a summary generation interface for generating activity and/or content change summaries utilizing a large language model. FIGS. 6A and 6B illustrate an example summary generation interface and various operations performable from the summary generation interface in accordance with one or more embodiments.

As illustrated in FIG. 6A, the activity difference system 106 generates and provides a summary generation interface 602 for display on a client device 600. Moreover, the activity difference system 106 generates, for display on the client device 600, digital content (such as a collaborative workspace as illustrated in FIGS. 6A and 6B). Furthermore, in some embodiments, within the summary generation interface 602, the activity difference system 106 provides a tools element 604.

Additionally, in some implementations, in response to receiving user input via user interaction with the tools element 604, the activity difference system 106 can generate for display a tools menu 606 with a summary pane element 608. Moreover, in response to user interaction with the summary pane element 608 of the tools menu 606, the activity difference system 106 can generate a summary pane for displaying and customizing activity and/or content change summaries as discussed further with respect to FIG. 6B.

In one or more embodiments, the activity difference system 106 generates the summary pane with the summary generation interface 602 without user interaction with the tools element 604. For example, in these or other embodiments, the activity difference system 106 generates the summary pane with the summary generation interface 602 in response to an access request or in response to detecting access to the collaborative workspace as described above.

As just mentioned, in one or more implementations, the activity difference system 106 generates a summary pane for displaying and customizing a summary (e.g., an activity and/or content change). For example, as illustrated in FIG. 6B, the activity difference system 106 generates the summary generation interface 602 and the summary pane (right of the vertical line separating the summary generation interface 602). As shown in FIG. 6B, in some embodiments, the activity difference system 106 provides a summary element 610 that provides the summary.

As further illustrated in FIG. 6B, within the summary pane of the summary generation interface 602, the activity difference system 106 provides user interface elements to perform various functions. Specifically, the activity difference system provides user interface elements within the summary pane for updating a summary generation prompt. Indeed, in these or other embodiments, the activity difference system 106 updates the summary generation prompt in response to user interaction with these user interface elements and provides the prompt to the LLM to generate a customized summary.

As shown, in some implementations, the activity difference system 106 generates and provides a timestamp element 612 for customization of timestamps. Specifically, the activity difference system 106 can provide the timestamp element 612 as an interactive element with a slider to define timestamps (e.g., timestamps A and B as shown in FIG. 6B). Indeed, in response to user interaction with the timestamp element 612, the activity difference system 106 can update the summary generation prompt with the defined timestamps to generate the summary to reflect user account activity, and/or content changes, of the collaborative workspace between the defined timestamps.

As further shown in FIG. 6B, the activity difference system 106 generates and provides an edit type selection element 614 that is selectable to customize the summary by activity type (i.e., user account activity type) or by content change type. For example, the activity difference system 106 can select one or more edit types such as modifications (e.g., or specific types of modifications), additions, removals, or other edit types.

Moreover, in one or more embodiments, the activity difference system 106 can generate multiple edit type elements. For example, the activity difference system 106 generates an activity type selection element that is selectable to customize the summary by activity type. Additionally or alternatively, the activity difference system 106 generates a content change selection element that is selectable to customize the summary by content change.

To illustrate, in one or more implementations, the activity difference system 106 can generate and provide the activity type selection element to include selectable user account activity types within a collaborative workspace (or specific content item) such as a modification to the location of a folder, a modification to a digital image, the addition or removal of a video, etc. Additionally or alternatively, the activity difference system 106 can generate and provide the content change type element to include selectable types of content changes to the collaborative workspace (or specific content items) such as a modification of a digital image, text additions or removals to a shared document, etc.

Furthermore, in response to user interaction with the edit type selection element 614 (or the activity type selection element and/or the content change type selection element), the activity difference system 106 generates an updated summary generation prompt including summary generation instructions for filtering the summary according to the selected edit type/s (e.g., to summarize only changes made by the selected edit types). Additionally, the activity difference system 106 provides the updated summary generation prompt to the large language model to generate the updated summary or summaries for display via the summary element 610.

As further illustrated, the activity difference system 106 generates and provides a user account selection element 616 that is selectable to customize the summary by user account. For example, the activity difference system 106 can select one or more user accounts from among the user accounts with access to the collaborative workspace. Further, in response to user interaction with the user account selection element 616, the activity difference system 106 generates an updated summary generation prompt including summary generation instructions for filtering the summary according to the selected user account/s (e.g., to only summarize changes made by selected accounts). Moreover, the activity difference system 106 provides the updated summary generation prompt to the large language model to generate the updated summary.

To illustrate, in response to user interaction with the user account selection element 616 selecting user account BB, the activity difference system 106 generates an updated summary reflecting activity and/or content changes made by BB to the digital video, the digital document, and/or to the digital folder within the relevant timeframe (between timepoint A and timepoint B). Because BB does not have access to the digital image, the activity difference system 106 does not include changes to the digital image in the summary even if changes were made to the digital image (e.g., by another user account within the relevant timeframe).

FIGS. 1-6B, the corresponding text, and the examples provide a number of different systems, methods, and non-transitory computer readable media for providing synopses of user account activity changes and/or actual content changes using a large language model. In addition to the foregoing, embodiments, can also be described in terms of flowcharts comprising acts for accomplishing a particular result. For example, FIGS. 7-9 illustrate flowcharts of example sequences of acts in accordance with one or more embodiments.

While FIGS. 7-9 illustrate acts according to some embodiments, alternative embodiments, may omit, add to, reorder, and/or modify any of the acts shown in FIGS. 7-9. The acts of FIGS. 7-9 can be performed as part of a method. Alternatively, a non-transitory computer readable medium can comprise instructions, that when executed by one or more processors, cause a computing device to perform the acts of FIGS. 7-9. In still further embodiments, a system can perform the acts of FIGS. 7-9. Additionally, the acts described herein may be repeated or performed in parallel with one another or in parallel with different instances of the same or other similar acts.

FIG. 7 illustrates an example series of acts 700 for providing synopses of user account activity changes for a collaborative workspace using a large language model. The series of acts 700 can include an act 702 of determining activity metadata defining user account activity performing actions within a collaborative workspace; an act 704 of generating a text representation of the user account activity; an act 706 of generating a summary generation prompt from the text representation; and an act 708 of generating an activity summary for the user account activity by providing the summary generation prompt to a large language model.

In some embodiments, the series of acts 700 can include an act of determining, for a collaborative workspace of a content management system, activity metadata defining user account activity across a plurality of user accounts performing actions within the collaborative workspace. The series of acts 700 can also include an act of generating, from the activity metadata, a text representation of the user account activity indicating the actions within the collaborative workspace that occur between a first timestamp and a second timestamp. The series of acts 700 can further include an act of generating a summary generation prompt from the text representation of the user account activity. Additionally, the series of acts 700 can include an act of generating an activity summary for the user account activity within the collaborative workspace between the first timestamp and the second timestamp by providing the summary generation prompt to a large language model.

In some implementations, the series of acts 700 can include an act of receiving an access request to access the collaborative workspace from a user account from among the plurality of user accounts. The series of acts 700 can also include an act of, in response to receiving the access request, determining the activity metadata defining the user account activity across the plurality of user accounts.

In one or more embodiments, determining the activity metadata defining the user account activity includes an act of extracting first metadata associated with a content item within the collaborative workspace at the first timestamp and second metadata associated with the content item at the second timestamp. Additionally, the series of acts 700 can include generating, utilizing a difference function to process the first metadata and the second metadata, an activity comparison file that defines differences in the user account activity between the first timestamp and the second timestamp. Moreover, in one or more implementations, generating the text representation of the user account activity includes an act of generating, utilizing a content conversion model, a text description of an activity comparison indicated in the activity comparison file between the first metadata and the second metadata.

In some embodiments, the series of acts 700 can include an act of defining the first timestamp as a time of most recent previous access of a user account from among the plurality of user accounts accessing the collaborative workspace. The series of acts 700 can also include an act of determining the second timestamp at a next successive time of the user account accessing the collaborative workspace after the first timestamp.

In some implementations, the series of acts 700 can include an act of defining at least one of the first timestamp or the second timestamp by utilizing user input to determine a time of the first timestamp or the second timestamp. Furthermore, in one or more embodiments, the series of acts 700 can include an act of generating, for display on a client device, an activity type selection element. The series of acts 700 can also include an act of determining, in response to user interaction with the activity type selection element, a selection of one or more activity types. Additionally, the series of acts 700 can include an act of generating the summary generation prompt to include instructions for filtering the activity summary according to the one or more activity types selected via the activity type selection element.

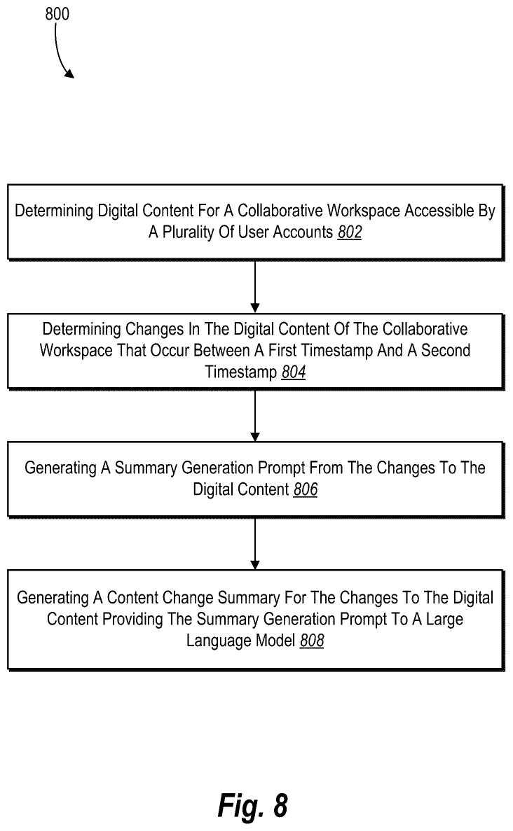

FIG. 8 illustrates an example series of acts 800 for providing synopses of content changes within a collaborative workspace using a large language model. The series of acts 800 can include an act 802 of determining digital content for a collaborative workspace accessible by a plurality of user accounts; an act 804 of determining changes in the digital content of the collaborative workspace that occur between a first timestamp and a second timestamp; an act 806 of generating a summary generation prompt from the changes to the digital content; and an act 808 of generating a content change summary for the changes to the digital content providing the summary generation prompt to a large language model.

In one or more implementations, the series of acts 800 can include an act of determining digital content for a collaborative workspace of a content management system accessible by a plurality of user accounts. The series of acts 800 can also include an act of determining changes in the digital content of the collaborative workspace that occur between a first timestamp and a second timestamp. Additionally, the series of acts 800 can include an act of generating a summary generation prompt from the changes to the digital content. Further, the series of acts 800 can include an act of generating a content change summary for the changes to the digital content within the collaborative workspace between the first timestamp and the second timestamp by providing the summary generation prompt to a large language model.

In some embodiments, the instructions cause the system to determine the changes in the digital content by extracting first digital content of the collaborative workspace at the first timestamp and extracting second digital content of the collaborative workspace at the second timestamp. Also, the series of acts 700 can include an act of generating, utilizing a difference function, a content difference file that defines differences between the first digital content from the second digital content.

In some implementations, the series of acts 800 can include generating, utilizing a difference function to process the changes in the digital content, a text representation of the changes in the digital content. Additionally, in one or more embodiments, the instructions cause the system to generate the summary generation prompt by generating summary generation instructions, and combining the summary generation instructions with the text representation of the changes in the digital content for providing to the large language model.

In one or more implementations, the series of acts 800 can include generating the summary generation instructions to be specific to at least one of a user account from among the plurality of user accounts or a type of content change. Moreover, in some embodiments, the series of acts 800 can include an act of generating a first text description of the digital content at the first timestamp and generating a second text description of the digital content at the second timestamp. Additionally, the series of acts 800 can include an act of generating a content comparison indicating the changes in the digital content by comparing the first text description with the second text description. In some implementations, the instructions cause the system to generate the summary generation prompt from the changes to the digital content indicated by the content comparison.

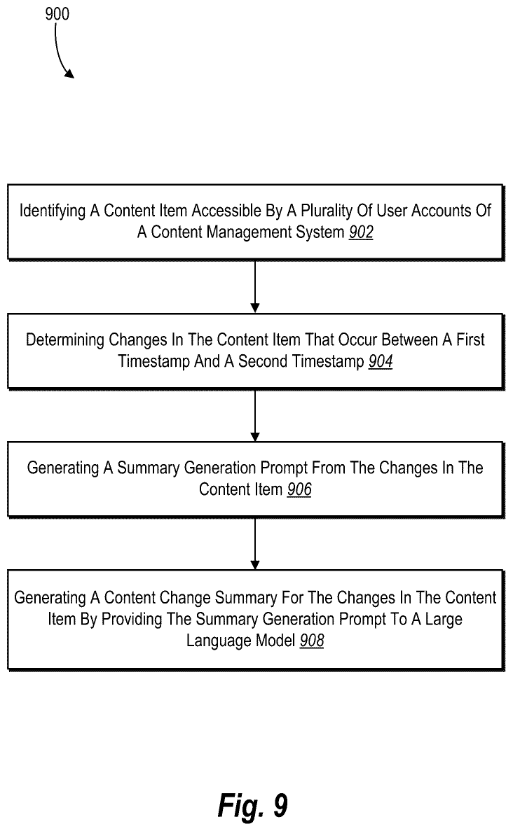

FIG. 9 illustrates an example series of acts 900 for providing synopses of content changes to a content item using a large language model. The series of acts 900 can include an act 902 of identifying a content item accessible by a plurality of user accounts of a content management system; an act 904 of determining changes in the content item that occur between a first timestamp and a second timestamp; an act 906 of generating a summary generation prompt from the changes in the content item; and an act 908 of generating a content change summary for the changes in the content item by providing the summary generation prompt to a large language model.

In one or more embodiments, the series of acts 900 can include an act of identifying a content item accessible by a plurality of user accounts of a content management system. The series of acts 900 can also include an act of determining changes in the content item that occur between a first timestamp and a second timestamp. Additionally, the series of acts 900 can include an act of generating a summary generation prompt from the changes in the content item. Further, the series of acts 900 can include an act of generating a content change summary for the changes in the content item between the first timestamp and the second timestamp by providing the summary generation prompt to a large language model.

In one or more implementations, the series of acts 900 can include an act of generating, utilizing a difference function, a text representation of the changes in the content item. Furthermore, in some embodiments, the series of acts 900 can include an act of generating the summary generation prompt from the text representation of the changes in the content item. Additionally, in some implementations, the instructions cause the at least one processor to generate the content change summary for the changes in the content item by providing the content item at the first timestamp and the content item at the second timestamp to the large language model with the summary generation prompt.

In one or more embodiments, the series of acts 900 can include an act of generating, for display on a client device, a timestamp element for customization of at least one of the first timestamp or the second timestamp. The series of acts 900 can also include an act of defining at least one of the first timestamp or the second timestamp based on user interaction with the timestamp element.

In one or more implementations, the series of acts 900 can include generating, for display on a client device, a user account selection element. Additionally, the series of acts 900 can include an act of determining, in response to user interaction with the user account selection element, a user account from among the plurality of user accounts. The series of acts 900 can also include an act of generating the summary generation prompt to include instructions for filtering the content change summary according to the user account.

The components of the activity difference system 106 can include software, hardware, or both. For example, the components of the activity difference system 106 can include one or more instructions stored on a computer-readable storage medium and executable by processors of one or more computing devices. When executed by one or more processors, the computer-executable instructions of the activity difference system 106 can cause a computing device to perform the methods described herein. Alternatively, the components of the activity difference system 106 can comprise hardware, such as a special purpose processing device to perform a certain function or group of functions. Additionally or alternatively, the components of the activity difference system 106 can include a combination of computer-executable instructions and hardware.

Furthermore, the components of the activity difference system 106 performing the functions described herein may, for example, be implemented as part of a stand-alone application, as a module of an application, as a plug-in for applications including content management applications, as a library function or functions that may be called by other applications, and/or as a cloud-computing model. Thus, the components of the activity difference system 106 may be implemented as part of a stand-alone application on a personal computing device or a mobile device.

Embodiments of the present disclosure may comprise or utilize a special purpose or general-purpose computer including computer hardware, such as, for example, one or more processors and system memory, as discussed in greater detail below. Implementations within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, implementations of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some implementations, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Implementations of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 10 illustrates a block diagram of exemplary computing device 1000 (e.g., the server(s) 102 and/or the client device(s) 110) that may be configured to perform one or more of the processes described above. One will appreciate that server(s) 102 and/or the client device(s) 110 may comprise one or more computing devices such as computing device 1000. As shown by FIG. 10, computing device 1000 can comprise processor 1002, memory 1004, storage device 1006, I/O interface 1008, and communication interface 1010, which may be communicatively coupled by way of communication infrastructure 1012. While an exemplary computing device 1000 is shown in FIG. 10, the components illustrated in FIG. 10 are not intended to be limiting. Additional or alternative components may be used in other implementations. Furthermore, in certain implementations, computing device 1000 can include fewer components than those shown in FIG. 10. Components of computing device 1000 shown in FIG. 10 will now be described in additional detail.

In particular implementations, processor 1002 includes hardware for executing instructions, such as those making up a computer program. As an example and not by way of limitation, to execute instructions, processor 1002 may retrieve (or fetch) the instructions from an internal register, an internal cache, memory 1004, or storage device 1006 and decode and execute them. In particular implementations, processor 1002 may include one or more internal caches for data, instructions, or addresses. As an example and not by way of limitation, processor 1002 may include one or more instruction caches, one or more data caches, and one or more translation lookaside buffers (TLBs). Instructions in the instruction caches may be copies of instructions in memory 1004 or storage device 1006.

Memory 1004 may be used for storing data, metadata, and programs for execution by the processor(s). Memory 1004 may include one or more of volatile and non-volatile memories, such as Random Access Memory (“RAM”), Read Only Memory (“ROM”), a solid state disk (“SSD”), Flash, Phase Change Memory (“PCM”), or other types of data storage. Memory 1004 may be internal or distributed memory.

Storage device 1006 includes storage for storing data or instructions. As an example and not by way of limitation, storage device 1006 can comprise a non-transitory storage medium described above. Storage device 1006 may include a hard disk drive (HDD), a floppy disk drive, flash memory, an optical disc, a magneto-optical disc, magnetic tape, or a Universal Serial Bus (USB) drive or a combination of two or more of these. Storage device 1006 may include removable or non-removable (or fixed) media, where appropriate. Storage device 1006 may be internal or external to computing device 1000. In particular implementations, storage device 1006 is non-volatile, solid-state memory. In other implementations, Storage device 1006 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

I/O interface 1008 allows a user to provide input to, receive output from, and otherwise transfer data to and receive data from computing device 1000. I/O interface 1008 may include a mouse, a keypad or a keyboard, a touch screen, a camera, an optical scanner, network interface, modem, other known I/O devices or a combination of such I/O interfaces. I/O interface 1008 may include one or more devices for presenting output to a user, including, but not limited to, a graphics engine, a display (e.g., a display screen), one or more output drivers (e.g., display drivers), one or more audio speakers, and one or more audio drivers. In certain implementations, I/O interface 1008 is configured to provide graphical data to a display for presentation to a user. The graphical data may be representative of one or more graphical user interfaces and/or any other graphical content as may serve a particular implementation.

Communication interface 1010 can include hardware, software, or both. In any event, communication interface 1010 can provide one or more interfaces for communication (such as, for example, packet-based communication) between computing device 1000 and one or more other computing devices or networks. As an example and not by way of limitation, communication interface 1010 may include a network interface controller (NIC) or network adapter for communicating with an Ethernet or other wire-based network or a wireless NIC (WNIC) or wireless adapter for communicating with a wireless network, such as a WI-FI.

Additionally or alternatively, communication interface 1010 may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, communication interface 1010 may facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Additionally, communication interface 1010 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

Communication infrastructure 1012 may include hardware, software, or both that couples components of computing device 1000 to each other. As an example and not by way of limitation, communication infrastructure 1012 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

FIG. 11 is a schematic diagram illustrating environment 1100 within which one or more implementations of the activity difference system 106 can be implemented. For example, the activity difference system 106 may be part of a content management system 1102 (e.g., the content management system 104). Content management system 1102 may generate, store, manage, receive, and send digital content (such as digital content items). For example, content management system 1102 may send and receive digital content to and from client devices 1106 by way of network 1104. In particular, content management system 1102 can store and manage a collection of digital content. Content management system 1102 can manage the sharing of digital content between computing devices associated with a plurality of users. For instance, content management system 1102 can facilitate a user sharing a digital content with another user of content management system 1102.

In particular, content management system 1102 can manage synchronizing digital content across multiple client devices 1106 associated with one or more users. For example, a user may edit digital content using client device 1106. The content management system 1102 can cause client device 1106 to send the edited digital content to content management system 1102. Content management system 1102 then synchronizes the edited digital content on one or more additional computing devices.

In addition to synchronizing digital content across multiple devices, one or more implementations of content management system 1102 can provide an efficient storage option for users that have large collections of digital content. For example, content management system 1102 can store a collection of digital content on content management system 1102, while the client device 1106 only stores reduced-sized versions of the digital content. A user can navigate and browse the reduced-sized versions (e.g., a thumbnail of a digital image) of the digital content on client device 1106. In particular, one way in which a user can experience digital content is to browse the reduced-sized versions of the digital content on client device 1106.

Another way in which a user can experience digital content is to select a reduced-size version of digital content to request the full- or high-resolution version of digital content from content management system 1102. In particular, upon a user selecting a reduced-sized version of digital content, client device 1106 sends a request to content management system 1102 requesting the digital content associated with the reduced-sized version of the digital content. Content management system 1102 can respond to the request by sending the digital content to client device 1106. Client device 1106, upon receiving the digital content, can then present the digital content to the user. In this way, a user can have access to large collections of digital content while minimizing the amount of resources used on client device 1106.

Client device 1106 may be a desktop computer, a laptop computer, a tablet computer, a personal digital assistant (PDA), an in- or out-of-car navigation system, a handheld device, a smart phone or other cellular or mobile phone, or a mobile gaming device, other mobile device, or other suitable computing devices. Client device 1106 may execute one or more client applications, such as a web browser (e.g., Microsoft Windows Internet Explorer, Mozilla Firefox, Apple Safari, Google Chrome, Opera, etc.) or a native or special-purpose client application (e.g., Dropbox Paper for iPhone or iPad, Dropbox Paper for Android, etc.), to access and view content over network 1104.

Network 1104 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which client devices 1106 may access content management system 1102.

In the foregoing specification, the present disclosure has been described with reference to specific exemplary implementations thereof. Various implementations and aspects of the present disclosure(s) are described with reference to details discussed herein, and the accompanying drawings illustrate the various implementations. The description above and drawings are illustrative of the disclosure and are not to be construed as limiting the disclosure. Numerous specific details are described to provide a thorough understanding of various implementations of the present disclosure.

The present disclosure may be embodied in other specific forms without departing from its spirit or essential characteristics. The described implementations are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

The foregoing specification is described with reference to specific exemplary implementations thereof. Various implementations and aspects of the disclosure are described with reference to details discussed herein, and the accompanying drawings illustrate the various implementations. The description above and drawings are illustrative and are not to be construed as limiting. Numerous specific details are described to provide a thorough understanding of various implementations.

The additional or alternative implementations may be embodied in other specific forms without departing from its spirit or essential characteristics. The described implementations are to be considered in all respects only as illustrative and not restrictive. The scope of the invention is, therefore, indicated by the appended claims rather than by the foregoing description. All changes that come within the meaning and range of equivalency of the claims are to be embraced within their scope.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
determining, for a collaborative workspace of a content management system, activity metadata defining user account activity across a plurality of user accounts performing actions within the collaborative workspace;
generating, from the activity metadata, a text representation of the user account activity indicating the actions within the collaborative workspace that occur between a first timestamp and a second timestamp;
generating a summary generation prompt from the text representation of the user account activity; and
generating an activity summary for the user account activity within the collaborative workspace between the first timestamp and the second timestamp by providing the summary generation prompt to a large language model.

2. The computer-implemented method of claim 1, further comprising:
receiving an access request to access the collaborative workspace from a user account from among the plurality of user accounts; and
in response to receiving the access request, determining the activity metadata defining the user account activity across the plurality of user accounts.

3. The computer-implemented method of claim 1, wherein determining the activity metadata defining the user account activity comprises:
extracting first metadata associated with a content item within the collaborative workspace at the first timestamp and second metadata associated with the content item at the second timestamp; and
generating, utilizing a difference function to process the first metadata and the second metadata, an activity comparison file that defines differences in the user account activity between the first timestamp and the second timestamp.

4. The computer-implemented method of claim 3, wherein generating the text representation of the user account activity comprises generating, utilizing a content conversion model, a text description of an activity comparison indicated in the activity comparison file between the first metadata and the second metadata.

5. The computer-implemented method of claim 1, further comprising:
defining the first timestamp as a time of most recent previous access of a user account from among the plurality of user accounts accessing the collaborative workspace; and
determining the second timestamp at a next successive time of the user account accessing the collaborative workspace after the first timestamp.

6. The computer-implemented method of claim 1, further comprising defining at least one of the first timestamp or the second timestamp by utilizing user input to determine a time of the first timestamp or the second timestamp.

7. The computer-implemented method of claim 1, further comprising:
generating, for display on a client device, an activity type selection element;
determining, in response to user interaction with the activity type selection element, a selection of one or more activity types; and
generating the summary generation prompt to include instructions for filtering the activity summary according to the one or more activity types selected via the activity type selection element.

8. A system comprising:
at least one processor; and
a non-transitory computer readable medium storing instructions that, when executed by the at least one processor, cause the system to:
determine digital content for a collaborative workspace of a content management system accessible by a plurality of user accounts;
determine changes in the digital content of the collaborative workspace that occur between a first timestamp and a second timestamp;
generate a summary generation prompt from the changes to the digital content; and
generate a content change summary for the changes to the digital content within the collaborative workspace between the first timestamp and the second timestamp by providing the summary generation prompt to a large language model.

9. The system of claim 8, wherein the instructions cause the system to determine the changes in the digital content by:
extracting first digital content of the collaborative workspace at the first timestamp;
extracting second digital content of the collaborative workspace at the second timestamp; and
generating, utilizing a difference function, a content difference file that defines differences between the first digital content from the second digital content.

10. The system of claim 8, further storing instructions that, when executed by the at least one processor, cause the system to generate, utilizing a difference function to process the changes in the digital content, a text representation of the changes in the digital content.

11. The system of claim 10, wherein the instructions cause the system to generate the summary generation prompt by:
generating summary generation instructions; and
combining the summary generation instructions with the text representation of the changes in the digital content for providing to the large language model.

12. The system of claim 11, further storing instructions that, when executed by the at least one processor, cause the system to generate the summary generation instructions to be specific to at least one of a user account from among the plurality of user accounts or a type of content change.

13. The system of claim 8, further storing instructions that, when executed by the at least one processor, cause the system to:
generate a first text description of the digital content at the first timestamp;
generate a second text description of the digital content at the second timestamp; and
generate a content comparison indicating the changes in the digital content by comparing the first text description with the second text description.

14. The system of claim 13, wherein the instructions cause the system to generate the summary generation prompt from the changes to the digital content indicated by the content comparison.

15. A non-transitory computer readable medium storing instructions that, when executed by at least one processor, cause the at least one processor to:
identify a content item accessible by a plurality of user accounts of a content management system;
determine changes in the content item that occur between a first timestamp and a second timestamp;
generate a summary generation prompt from the changes in the content item; and
generate a content change summary for the changes in the content item between the first timestamp and the second timestamp by providing the summary generation prompt to a large language model.

16. The non-transitory computer readable medium of claim 15, further storing instructions that, when executed by the at least one processor, cause the at least one processor to generate, utilizing a difference function, a text representation of the changes in the content item.

17. The non-transitory computer readable medium of claim 16, further storing instructions that, when executed by the at least one processor, cause the at least one processor to generate the summary generation prompt from the text representation of the changes in the content item.

18. The non-transitory computer readable medium of claim 15, wherein the instructions cause the at least one processor to generate the content change summary for the changes in the content item by providing the content item at the first timestamp and the content item at the second timestamp to the large language model with the summary generation prompt.

19. The non-transitory computer readable medium of claim 15, further storing instructions that, when executed by the at least one processor, cause the at least one processor to:
generate, for display on a client device, a timestamp element for customization of at least one of the first timestamp or the second timestamp; and
define at least one of the first timestamp or the second timestamp based on user interaction with the timestamp element.

20. The non-transitory computer readable medium of claim 15, further storing instructions that, when executed by the at least one processor, cause the at least one processor to:
generate, for display on a client device, a user account selection element;
determine, in response to user interaction with the user account selection element, a user account from among the plurality of user accounts; and
generate the summary generation prompt to include instructions for filtering the content change summary according to the user account.
